(19) United States
(12) Patent Application Publication
(10) Pub. No.: US 2004/0109789 A1
(43) Pub. Date: Jun. 10, 2004

(54) Dosimeter for sun radiation for use with sunscreen lotion

(76) Inventors: Ori Faran, Haifa (IL); Ezra Natan, Haifa (IL); Dmitri Lastochkin, Granger, IN (US)

Correspondence Address: BLANK ROME LLP, 600 NEW HAMPSHIRE AVENUE, N.W., WASHINGTON, DC, 20037, US

(21) Appl. No.: 10/148,837

(22) PCT Filed: Dec. 4, 2000
(86) PCT No.: PCT/IL00/00814

(51) Int. Cl. G01N 21/00

(52) U.S. Cl. 422/58; 436/57

(57) ABSTRACT

Disposable dosimeter for sun radiation comprising polymeric matrix with distributed therein at least one active chemical compound capable to change its original color to a new color due to a reversible photo-chemical reaction induced upon exposing the dosimeter to UV radiation. The transparency of the matrix is sufficient to enable easy visual detection of the change of the original color to the new color. The matrix is provided with porous structure suitable for absorbing thereinto of a sunscreen loti n when it is applied to the dosimeter.

### FIELD OF THE INVENTION

The present invention refers to an ultraviolet radiation dosimeter.

The ultraviolet region (UV region) is a region of the electromagnetic spectrum adjacent to the low end of the visible spectrum. The UV region extends between 400-100 nm. and is divided into 3 sub regions: the UVA region (400-320 run), the UVB region (320-280 nm), and the UVC region (280-100 nm).

The must dangerous to human beings radiation is the radiation in the UVB region since it causes several types of skin cancer. One type of this cancer, namely melanoma, is lethal. In addition to the above, excessive exposure to radiation in the UVB region can cause skin aging and is also harmful to eyes.

Radiation in the UVA region also causes damage such as photo aging, to the skin. Radiation in the UVC region does not penetrate the ozone layer, which fortunately also blocks most of the radiation in the UVB and the UVA region.

During the last two decades the level of UV radiation that reaches earth has increased substantially due to the depletion of the ozone layer which is associated with the release of various chemicals in the form of aerosols into the atmosphere.

In some parts of the world the level of UV radiation has increased by 30-50%. Thus exposure to sun radiation is even more dangerous.

It is believed, for example, that every 1% of increase in the level of UV radiation corresponds to 4% increase in the number of skin cancer cases. Indeed, according to medical statistics the number of skin cancer cases has increased by hundreds of percents in the last 20 years.

UV radiation induces biological effects depending on the particular wavelength of the radiation. It is known to evaluate the total biological or hazard weighted irradiation by multiplying the spectral irradiation at each wavelength by the biological or hazard weighted factor and then summation results of the multiplying over all the wavelengths.

Biological or hazard factors are obtained from so-called action spectrum according to Environmental health criteria 160 “Ultraviolet radiation” issued by the World Health Organization. Geneva, 1994. An action spectrum is a graph of the reciprocal of the radiant exposure required to produce the given harmful effect at each wavelength. All the data in such graphs are normalized to the datum at the must efficacious wavelength. By summation of the biologically effective irradiation over the exposure period, the biologically effective radiant exposure (efficacy in J/m²) can be calculated.

The action spectrum graph for UV induced erythema was adopted worldwide by many organizations such as:

1. ACGIH (American Conference of Governmental Industrial Hygienists)

2. WHO (World Health Organization)

3. UNEP (United Nations Environment Program)

4. INIRC (International Non Ionizing Radiation Committee)

The action spectrum graph is a complex curve, obtained by statistical analysis of many research results establishing the minimum radiant exposure to the UV radiation at different wave lengths sufficient for effecting erythema.

The most commonly used quantity of radiation associated with the erythemal potential due to the exposure to UV radiation is the number of so-called minimum erythemal doses (MED) caused by the exposure. An MED is defined as the radiant exposure of the UV radiation that produces a just noticeable erythema on a previously unexposed skin. The radiant exposure to monochromatic radiation at around 300 nm with the maximum spectral efficacy, which is required for erythema corresponds to approximately 200 to 2000 J/m² efficacy depending on the skin type.

Human skin reacts to radiation by changes in the melanin content. Subsequent to the change in the melanin content reddening occurs, and then soreness and signs of sun burning appear.

There exist 5 types of skin types that differ according to the color of human hair eyes and skin and by their reaction to overexposure to UV radiation. The permissible time for exposure to UV radiation on a mid summer day changes from 30 minutes for skin type no.2 to about 2 hours for skin type no.4 (without using sun screen).

In practice the UV radiation level changes continuously, due to the angle of the sun, latitude, level of air pollution, season of year, presence of clouds, height above the sea and other factors. Therefore, it is very difficult to provide accurate, reliable and timely warnings to the public about the UV radiation levels for specific location and day time. The only practical means that the public can use to defend itself is a personal dosimeter.

Most people are not aware of the danger that can arise even after limited exposure to UV radiation, because the dose is accumulated during the exposure for varying periods of time in a daily life routine. The first visible sign is usually sunburn, which might only become visible after a few hours. This means that the individual becomes aware of the danger only after the damage has already been done. In medical literature it is known that the so-called “repair time” of the human skin is in the order of one day. It should be emphasized that skin cancer might even appear years later.

It is also very well known to use sunscreen lotions for protecting the skin from sun radiation and there are available plenty of brands of sunscreen manufactured by various companies. When people use sunscreens lotions they must repeat applying it on the skin during the whole period of exposure, since the lotion can loose it efficiency after it has been absorbed by the skin. The lotion can be also be unintentionally removed by mechanical friction due to contact with water, sand, etc.

Nevertheless, people usually are not aware of the above and believe they are safe ones the sunscreen lotion is put on their skin. The manufacturers provide their products with so-called SPF (sun protection factor). The value of this factor indicates how much you increase the time period during which an individual using the lotion is allowed to be exposed to sun radiation. It should be emphasized that this factor neither refers to the above mentioned skin type, nor the season or meteorological conditions.

There are known various patents disclosing disposable dosimeters designed to warn about the amount of sun radiation absorbed and thus to inform an individual when he should terminate exposure to sun radiation.

Among those patents can be mentioned U.S. Pat. No. 4,829,187, U.S. Pat. No. 5,117,116, U.S. Pat. No. 3,903,243, U.S. Pat. No. 3,787,687, U.S. Pat. No. 5,612,541 and others.

It can be assumed that using a dosimeter in combination with the sunscreen lotion could provide the user with more reliable information about permissible duration of exposure to sun radiation. However, none of the known in the art dosimeters is suitable for use in combination with the sunscreen lotion, neither is it intentionally designed for carrying sunscreen lotion. Furthermore it can be assumed that once sunscreen lotion is applied to the known dosimeters the active photo-chemical substance employed therein may loose ability to undergo photo-chemical reaction responsible for the dosimeter's performances

Thus, one can see that there is a need for a new and improved dosimeter that can perform in combination with a sunscreen lotion and is able to provide the user with reliable information about permissible duration of exposure to sun radiation irrespective of the user's skin type, season, meteorological condition and other factors

### SUMMARY OF THE INVENTION

The main aim of the present invention is to provide for a new and improved dosimeter, which is suitable for carrying a sunscreen lotion and for alerting the user when to apply the lotion again or to terminate the exposure to sun radiation.

The further object of the invention is to provide for a new dosimeter for use in combination with a lotion and capable to alert the user to terminate the exposure in accordance with particular SPF number of the lotion.

Another object of the invention is to provide for a new dosimeter defined by open porous structure suitable for absorbing sunscreen lotion thereunto without deterioration of the dosimeter's performances.

Still further object of the invention is to provide for a new dosimeter that is simple, cheap and convenient and thus is suitable for use by individuals in every day routine.

The other object of the present invention is to provide for a dosimeter employing active photochromic compound that changes its color after exposure to sun radiation with the efficacy of at least 1 MED irrespective of the user's skin type.

### BRIEF DESCRIPTION OF THE DRAWINGS

FIG. 1 shows example of an action spectra graph.

FIG. 2 shows relative intensity of UV solar radiation versus wavelength.

FIG. 3 is graphic illustration of solar radiation efficacy as a function of time. The graph refers to skin type No.2 and corresponds to 1 MED monochromatic radiation with wavelength 297 nm.

FIGS. 4a,b show how new dosimeter can be worn immediate on a user's hand or attached to a strap.

FIG. 5 shows schematically porous structure of the dosimeter of the present invention.

FIG. 6 shows general structural chemical formula of spiropyrans and spiroxazines suitable for use with the dosimeter of the present invention.

FIG. 7 shows an example of photochemical reaction responsible for change of color in spiropyrans and spirooxazines.

FIG. 8 presents general structural formula referring to naphthopyrans suitable for use in the present invention.

FIG. 9 is an example of photochemical reaction, which is employed in the present invention

FIG. 10 shows general structural formula of bisimidazole derivatives suitable for use in the present invention.

FIG. 11 shows another example of photochemical reaction employed in the present invention.

### DETAILED DESCRIPTION OF THE PREFERRED EMBODIMENTS

Since the present invention refers to a dosimeter and not to a detector of sun radiation, it is very important that it be attached to the user's clothing or equipment in such a manner that the dosimeter absorbs the same amount of sun radiation as the user exposed to it.

The specific photochromic substances employed in the dosimeter of the present invention are selected in such a manner that they are sensitive to exposure to solar radiation in the UV region, but not necessarily at the wavelengths which corresponds to the peak of action spectrum as shown in FIG. 1. This precondition is chosen since this wavelength range (around 300 nm) is beyond the visible spectrum within it is desirable that the color changes will occur.

On the other hand the desirable wavelength range in which the photochromic compound changes its color should not be too far from the wavelength corresponding to the action spectrum peak. This is required in order to eliminate possible mistakes associated with extrapolation from the wavelength at which a particular photochromic compound changes its color to the wavelength corresponding to the action spectrum peak.

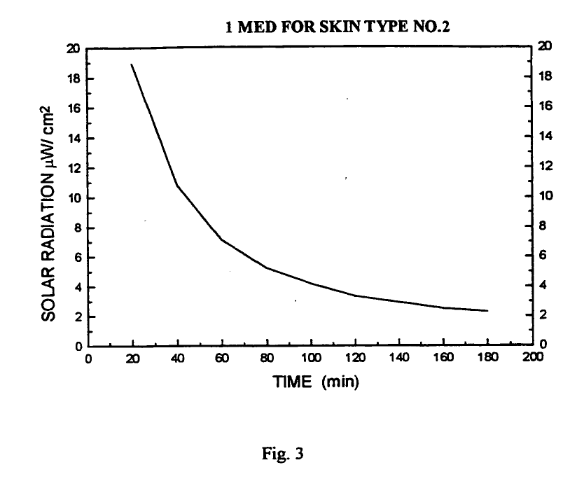

The amount of UV radiation that can present danger to an individual exposed to sun radiation is determined on the basis of existing action spectra and available data for each skin type. An example of this dependency referring to skin type No. 2 is shown in FIG. 3.

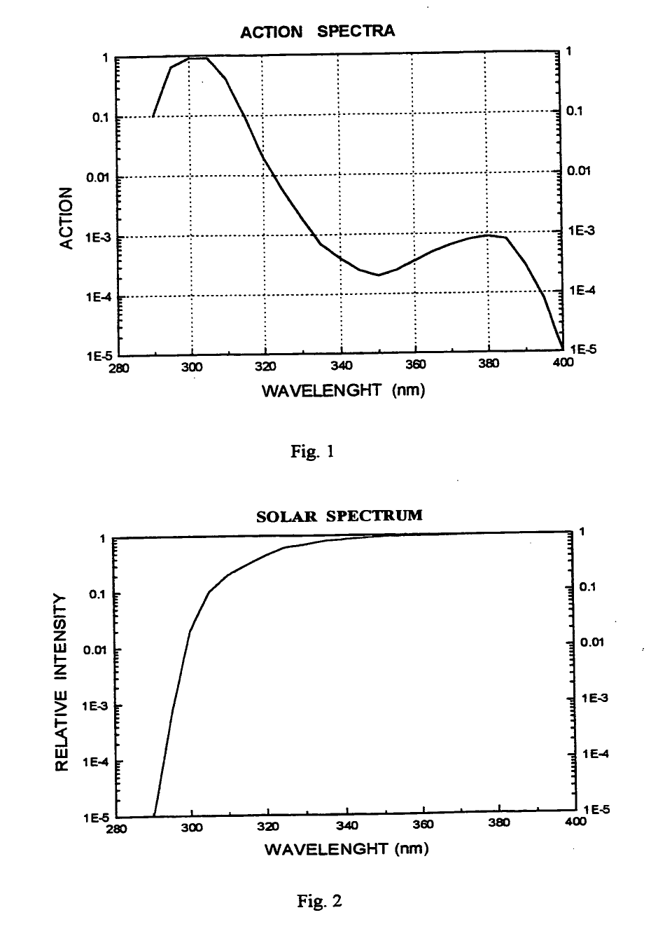

The effective intensity of irradiation at particular wavelength or range, to which the employed photochromic compound is sensitive, is determined from the dependence of UV radiation intensity vs. wavelength. An example of this function is shown in FIG. 2. This intensity is then extrapolated to the intensity of an irradiation that takes place at 297 nm and at the conditions to which the user will be exposed.

To provide the dosimeter with ability to function at these conditions it was calibrated by exposing thereof to sun radiation during different seasons and different daytime. For calibration was used PMA2100 digital dosimeter and PMA2101 UVB detector, manufactured by Solar Light Co.

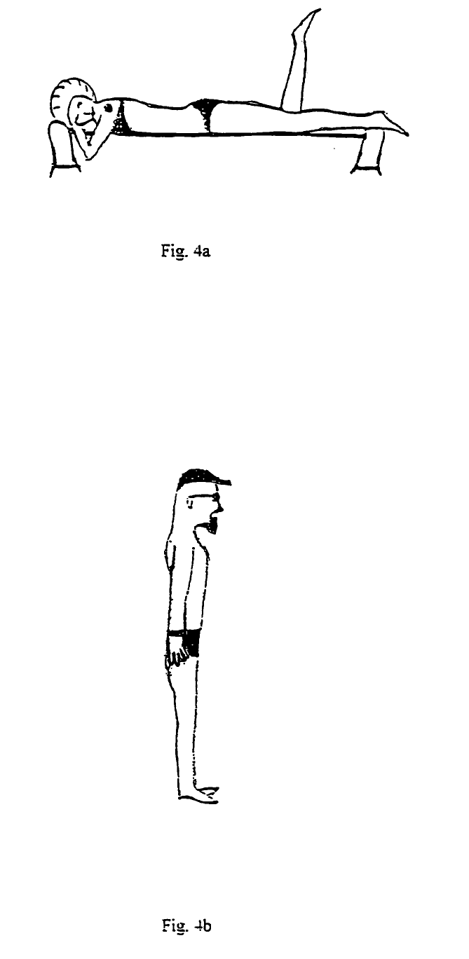

With reference to FIGS. 4a,b it is shown how the new dosimeter can be applied immediate to user's skin or to a bracelet, strap etc. to be worn on user's hand.

In accordance with the present invention the dosimeter comprises:

an active chemical compound capable to undergo reversible photo-chemical reaction accompanied by changing its color

an inhibiting agent capable to stress the change of color and at the same time to inhibit the reverse photo-chemical reaction.

The dosimeter of the invention can also comprise a modifying additive, e.g.a UV absorbing agent, a pigment etc.

The above constituents, i.e. active chemical compound, inhibiting agent and modifying additive are distributed within a polymeric matrix. The particular active chemical compound, the inhibiting agent and modifying additive are selected in such a manner that the dosimeter changes its color during the exposure to solar radiation with efficacy corresponding the individual's personal permissible MED corresponding to his personal skin type.

In accordance with the invention there can be provided up to 5 types of dosimeters, correspondingly referring to one of the 5 known skin types. Since the new dosimeter operates irrespective of whether it is exposed to direct or reflected, continuous or intermittent sun radiation the dosimeter does not affect the user's daily activities.

By virtue of this provision the public's attitude to using such a dosimeter will be more positive and thus the awareness to the danger of excessive exposure to UV radiation will be increased.

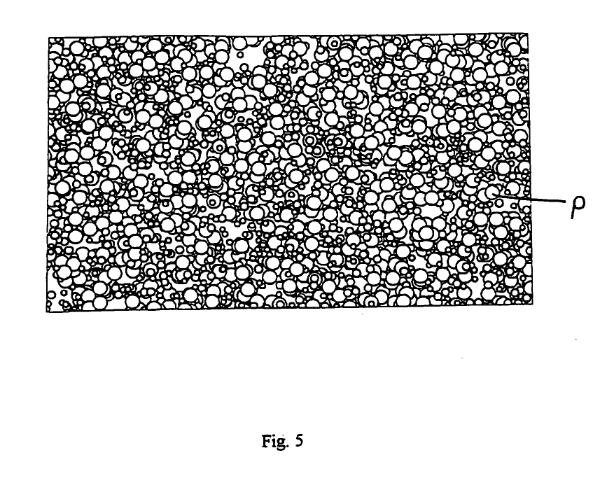

With reference to FIG. 5 it is shown the construction of the dosimeter. The dosimeter comprises a polymeric matrix that is shaped in the form of a flat sheet having thickness 0.1-0.5 mm.

The aim of the matrix is to carry therein the active chemical compound along with the other above-mentioned components, to reliably protect them from ambient humidity and to impart machinability.

It has been revealed that it is possible to carry sunscreen lotion within the polymeric matrix if it is provided with porous structure characterized by pore size in the range of 0.01 mm-1 mm. The most suitable porous matrix should have surface density of pores in the range of 10-10³ pores per square cm. The pores should be defined substantially by ellipsoidal cross section shape and their length should be in the range of 10-100 micrometers.

Since the above-described porous structure imitates human skin it is very suitable for absorbing sunscreen lotion therein. The porous structure can be created by any known in the art physical or chemical manufacturing methods, e.g. blowing, foaming etc.

The physical methods are advantageous since they do not require introducing of additional chemical substances within the matrix. The disadvantage of physical method is associated with the necessity in sophisticate dedicated equipment.

The chemical methods employ dedicated chemical substances that often are referred—to as “foaming agents”. Examples of suitable foaming agents are: azodicarbonamide, sodium bicarbonate, sulfonyl hydrazides, 5-phenyltetrazole, sodium borohydride etc.

The matrix material should be thermally stable. i.e. it should not alter its transparency after heating up to 50 degrees C. so as to allow visualizing the variation of color of the active compound incorporated in the matrix.

As an example of suitable matrix material one can mention various optically transparent plastic materials, e.g. polycarbonates, polystyrenes, polyolifines, polyacrylates such as polymethylmethacrylates, polyvinyl derivatives, polyesther derivatives, polyvinyl chloride; cellulose derivatives such as cellulose acetate, polyurethanes, polyethylene terephthalate; silicone resins such as LSR (liquid silicone rubber), triethylene glycole dimethacrylate (TEGDM, commercially known as CR-39), epoxy resins etc. Transparent copolymers and blends of dissimilar transparent polymers are also suitable as matrix material.

FIG. 5 shows the matrix with an active photochromic compound distributed therein. It can be seen that the matrix is defined by porous structure with pores designated by numeral P.

The principle of choosing of the active compound in accordance with the present invention will be explained further.

In accordance with the invention the matrix should also contain a inhibiting agent capable to stress the change of color induced in the active chemical compound upon exposure to sun radiation. By virtue of this provision it is possible to use the dosimeter even when it is exposed to intermittent sun radiation which is accumulated by the dosimeter. Non-limiting list of suitable inhibiting agents includes:

carbontetrachloride,

bromotrichloromethane.

1,1,2,2-tetrabroethane.

α,α,α-trichlorotoluene,

2,4-dinitrobenzenesulfenylchloride,

ω,ω,ω-tribromoquinaldine,

ω,ω,ω-tribromolepidinebromomethylate, α,ω,ω-dibromomethyl-4-chloro-pyridi-2.5-dinitrobromomethyl

-3,4-dibromothiophene, acetophenone derivatives, thioxanthone derivatives or their combinations.

The matrix may contain modifying additive such as an UV absorbing agent or color pigment distributed therein. Some examples of materials suitable for use as absorbing agents include:

2,4-bis(2,4-dimethylphenyl)-6-(2-hydroxy-4-n-octyl-oxyphenyl)-1,3, 5-triazine.

2-hydroxy-4-(N-octoxy)benzophenone.

2-(2-hydroxy-5-methyl-phenyl)-2H-benzotriazole.

2-(2H-benzotriazol-2-YL)-4,6-ditertpentylphenol.

2,2′-dihydroxy-4,4′-dimethoxybenzophenone.

2,2′,4,4′-tetrahydroxybenzophenone.

The mixture consisting of active chemical compound, inhibiting agent and modifying additive can be incorporated within the polymeric matrix by means of any known-in-the-art suitable method, for example by compounding, etc.

The dosimeters can be shaped from the compounded matrix with the constituents by any known-in-the-art suitable method, for example by injection molding or by extrusion.

In practice the amounts of the active chemical compound and of the modifying additive vary as follows:

0.05-0.5 weight % of active chemical compound

0.05-0.5 weight % of inhibiting agent

The above amounts vary depending on the matrix material, particular type of the active chemical compound employed and particular skin type to whom it intend.

It is possible also to distribute the constituents in such a manner that there is created gradient of their effective concentration, e.g. as it is disclosed in U.S. Pat. No. 6,132,681 herein incorporated for reference.

By virtue of this provision it is possible to control more efficiently the amount of radiation accumulated by the active compound residing in different locations within the matrix and thus to achieve dynamic response of the active compound to the radiation dose the user has been exposed to.

It can be also advantageous to add to the polymeric matrix a dye or an auxiliary pigment in order to improve visual detection of the change of color. Some examples of pigments suitable for this purpose are: Phtalocyanine, Quinacridone, Isoindolinone. Perylene, Anthraquinone, etc.

Having explained the construction of the new dosimeter it will now be explained in more detail how the active chemical compound employed therein is chosen.

It has been empirically established that those photochromic compounds, which satisfy the following criteria, can be advantageously employed in the dosimeter of the present invention:

1. The active chemical compound should be capable of undergoing photochemical reaction accompanied by coloration in response to continuous or intermittent UV radiation which cumulative efficacy corresponds to at least 1 MED depending to user's skin type.

2. The active chemical compound should not change its new color or reverse to its original color after it has been exposed to sun radiation for at least 4 hours and at a temperature up to 50° C.

3. The mechanism of photochemical reaction responsible for coloration of the active chemical compound should be formation of ions or radical dissociation.

4. The active chemical compound should be compatible with commercially available sunscreen lotions irrespective of their type or SPF number.

Some non-exhaustive representative examples of suitable active chemical compounds satisfying the above criteria are listed below:

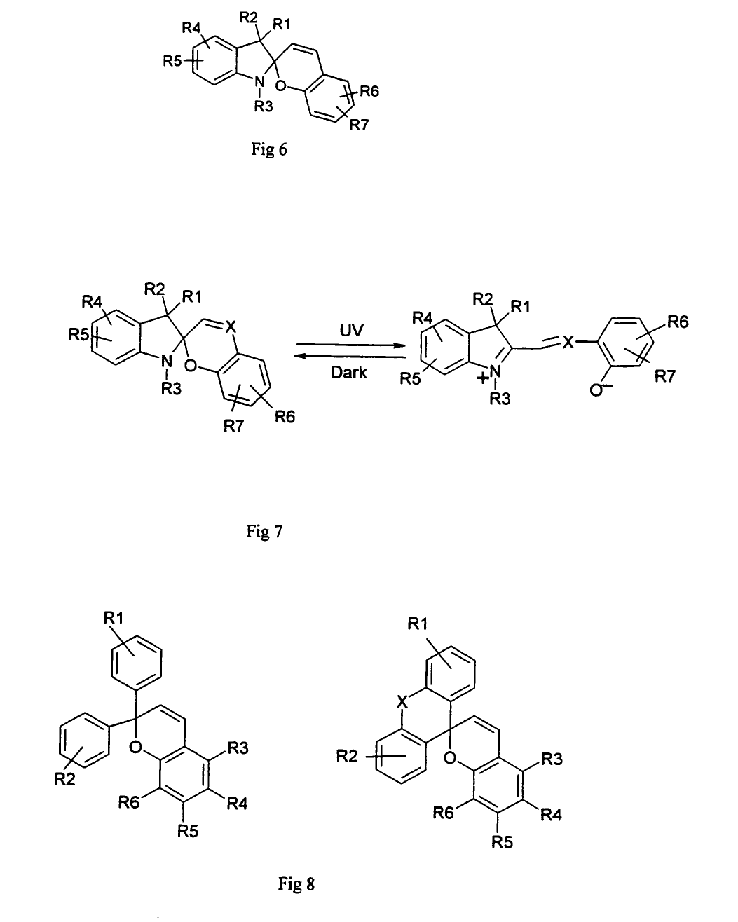

a) Spiropyrans derivatives that are represented by general structural formula shown in FIG. 6. In the above formula R₁, R₂, R₃, R₅, R₆ R₇ represent independently an alkyl group, an aromatic group, an alkoxy group, a nitro group or a halogen. Examples of these derivatives can be found in Berman, E.; Fox, R. J. Am. Chem. Soc, 81, 5605 (1959). It has been found, however that derivatives of naphtospyropyrans are not within the scope of this invention.

The mechanism of photochemical reaction responsible for coloration is formation of ions. Example of this mechanism is presented in FIG. 7.

b) Naphthopyrans derivatives represented by general structural formula shown in FIG. 8. In the above formula X═O, S, N—R₁(CH₂)ₙ and n=0, 1, 2, etc. R₁, R₂, R₃, R₄, R₅, R₆ represent independently an alkyl group, an alkoxy group, a nitro group or a halogen. R₃-R₄, R₅-R₆ can also represent independently only a sole group, like an aromatic group, an alkoxy or thioaromatic group, for example as described in Van Germert, B Mol. Cryst. Liq. Cryst., 1997, Vol.297,p. 131.

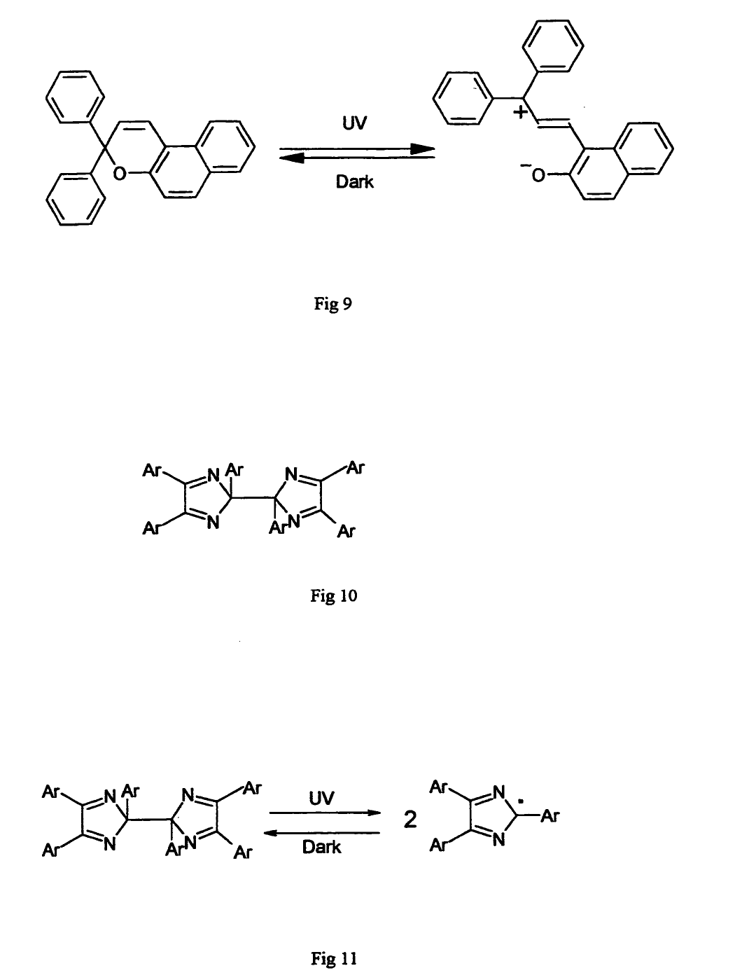

The mechanism of photochemical reaction responsible for coloration is formation of ions. Example of this mechanism is presented in FIG. 9.

c) Bisimidazoles derivatives for example as described in White, D. M.; Sonnenberg, J. J. Org. Chem., 29, 1926 (1964). This group of compounds is represented by general structural formula shown in FIG. 10. In the above formula R represents a phenyl group, a methylphenyl group, a methoxy phenyl group or a halogen phenyl group.

The photochemical reaction responsible for coloration is presented in FIG. 11. The mechanism of this reaction is radical dissociation.

The present invention will now be disclosed with reference to non-limiting examples 1-3 below.

### EXAMPLE No. 1

A dosimeter for skin type No. 2 was produced by extrusion from matrix made of low-density polyethylene compound containing all necessary components.

The Matrix was Prepared as Follows:

A) 1.5 g of active chemical compound, namely 1′,3′-Dihydro 1′,3′,3′-trimethyl-6-nitrospiro[2H-1-benzopyran-2-2′-(2H)-indole] was compounded at 180 degrees C. with 2 g of inhibiting agent, namely α, α, α-trichlorotoluene and with 500 g of low density polyethylene.

B) 5 g of azodicarbonamide foaming agent, namely Genitron EPB, manufactured by Ciba Gaigy Ltd., Switzerland was compounded at 180 degrees C. with 5 g of a pigment, namely masterbatch of red color pigment L-5418, manufactured by Kafrit Ltd. Israel and with 500 g of low-density polyethylene.

C) The above amounts of compounds prepared according to steps A,B were mixed together and shaped by extrusion casting to obtain thin film with thickness 0.3 mm and with porous structure.

The porous structure was defined by pores size 0.01-0.05 mm, pores surface density 1*10³ pores per cm² and by pores length 50-100 micron.

A sunscreen lotion, namely Pizzbuin, SPF 5, manufactured by Pizzbuin, Switzerland was applied on the upper surface of the dosimeter prepared in accordance with the above procedure.

The dosimeter was exposed to sun radiation with an average intensity of 2 MED/Hour so as to accumulate 1 MED. The exposure took place during different seasons and during different daytime. For calibration of the dosimeter was used digital dosimeter PMA2100 with detector PMA2101 UVB manufactured by Solar Light Co.

Upon exposure the dosimeter immediately changed its color from red to blue and then returned to original red color after 2 hours. The final color of the dosimeter was not influenced neither by prolonged exposure to sun radiation, nor by heating up to 50 degrees C.

The same dosimeter but without sunscreen lotion was exposed to the same amount of UV radiation and at the same conditions. The dosimeter returned to the original color after 0.5 hour.

### EXAMPLE No.2

A dosimeter for skin type No. 1 was produced by extrusion from matrix made of low-density polyethylene compound containing all necessary components.

The Matrix was Prepared as Follows:

A) 1.5 g of active chemical compound, namely 1′,3′-Dihydro-1′,3,3′-trimethyl-6-nitrospiro[2H-1-benzopyran-2-2′-(2H)-indole] was compounded at 180 degrees C. with 2 g of inhibiting agent, namely α,α,α-trichlorotoluene and with 500 g of low density polyethylene.

B) 5 g of azodicarbonamide foaming agent, namely Genitron EPB, manufactured by Ciba Gaigy Ltd., Switzerland was compounded at 180 degrees C. with 0.5 g of a pigment, namely masterbatch of orange color pigment L-4299, manufactured by Kafrit Ltd., Israel and with 500 g of low-density polyethylene.

C) The above amounts of compounds prepared according to steps A,B were mixed together and shaped by extrusion casting to obtain thin film with thickness 0.3 mm and with porous structure.

The porous structure was defined by pores size 0.01-0.05 mm, pores surface density 1*10³ pores per cm² and by pores length 50-100 micron.

A sunscreen lotion, namely Pizzbuin, SPF 15, manufactured by Pizzbuin, Switzerland was applied on the upper surface of the dosimeter prepared in accordance with the above procedure.

The dosimeter was exposed to sun radiation with average intensity of 3 MED/Hour so as to accumulate 1 MED. The exposure took place during different seasons and during different daytime. For calibration of the dosimeter was used digital dosimeter PMA2100 with detector PMA2101 UVB manufactured by Solar Light Co.

Upon exposure the dosimeter immediately changed its color from orange to violet and then returned to original orange color after 2 hours. The final color of the dosimeter was not influenced neither by prolonged exposure to sun radiation, nor by heating up to 50 degrees C.

The same dosimeter but without sunscreen lotion was exposed to the same amount of UV radiation and at the same conditions. The dosimeter returned to the original color after 0.33 hour.

### EXAMPLE No.3

A dosimeter for skin type No. 3 was produced by extrusion from matrix made of low density polyethylene compound containing all necessary components.

The Matrix was Prepared as Follows:

a) A) 1.5 g of active chemical compound, namely 1′,3′-Dihydro-1′,3′,3′-trimethyl-6-nitrospiro[2H-1-benzopyran-2-2′-(2H)-indole] was compounded at 180 degrees C. with 3 g of inhibiting agent, namely α,α,α-trichlorotoluene and with 500 g of low density polyethylene.

b) B) 5 g of azodicarbonamide foaming agent, namely Genitron EPB,

manufactured by Ciba Gaigy Ltd., Switzerland was compounded at 180 degrees C. with 0.5 g of auxiliary pigment, namely masterbatch of yellow color pigment L-3493, manufactured by Kafrit Ltd., Israel and with 500 g of low-density polyethylene.

c) C) The above amounts of compounds prepared according to steps A,B were mixed together and shaped by extrusion casting to obtain thin film with thickness 0.3 mm and with porous structure.

The porous structure was defined by pores size 0.01-0.05 mm, pores surface density 10³ pores per cm² and by pores length 50-100 micron.

A sunscreen lotion, namely Pizzbuin, SPF 30, manufactured by Pizzbuin, Switzerland was applied on the upper surface of the dosimeter prepared in accordance with the above procedure.

The dosimeter was exposed to sun radiation with average intensity of 3 MED/Hour so as to accumulate 1 MED. The exposure took place during different seasons and during different daytime. For calibration of the dosimeter was used digital dosimeter PMA2100 with detector PMA2101 UVB manufactured by Solar Light Co.

Upon exposure the dosimeter immediately changed its color from yellow to violet. Then upon accumulating 3 MED it gradually changed the color to brown and finally after 3.5 hours became yellow. The final yellow color of the dosimeter was not influenced neither by prolonged exposure to sun radiation, nor by heating up to 50 degrees C.

The same dosimeter but without sunscreen lotion was exposed to the same amount of UV radiation and at the same conditions. The dosimeter returned to the original color after 0.5 hour.

Since the time for returning to the original color is rather long it is possible to use the intermediate color as an indication when the lotion should be applied again instead of terminating the exposure to sun radiation.

It should be appreciated that the present invention is not limited to the above-described embodiments and that one ordinarily skilled in the art can make modifications without deviation from the scope of the invention, as will be defined in the appended claims.

It should be appreciated that the features disclosed in the foregoing description, and/or in the following claims, and/or in the accompanying drawings and/or in the accompanying examples may, both separately and in any combination thereof, be material for realizing the present invention in diverse forms thereof.

1. A disposable dosimeter for sun radiation comprising a polymeric matrix with distributed therein at least one active chemical compound capable to change its original color to a new color due to a reversible photo-chemical reaction induced upon exposing the dosimeter to UV radiation, the transparency of said matrix is sufficient to enable easy visual detection of the change of the original color to the new color, wherein said matrix is provided with porous structure suitable for absorbing thereinto of a sunscreen lotion when it is applied to the dosimeter.

2. The dosimeter as defined in claim 1, in which said matrix comprises at least one inhibiting agent suitable to improve visual detection of the change of the original color, said inhibiting agent is capable to inhibit the reverse photo-chemical reaction, wherein said active chemical compound is capable to change the original color after the dosimeter has been exposed to UV radiation with accumulated dosage of at least 1 MED, said color change retains up to 50 degrees C. and/or during exposure to visible light.

3. The dosimeter as defined in claim 2, in which said matrix comprises at least one absorbing agent capable to absorb and to control the total amount of the UV radiation accumulated by the dosimeter

4. The dosimeter as defined in claim 3, in which said matrix comprises a Color pigment.

5. The dosimeter as defined in claim 1, in which said said matrix is selected from the group consisting of polycarbonates, polystyrenes, polyolifines, polyacrylates such as polymethylmethacrylates, polyvinyl derivatives, polyesther derivatives, polyvinyl chloride, cellulose derivatives such as cellulose acetate, polyurethanes, polyethylene terephthalate, silicone resins, triethylene glycole dimethacrylate, epoxy resins etc. taken alone or in combination thereof.

6. The dosimeter as defined in claim 1, in which said active chemical compound is selected from the group consisting of spiropyrans derivatives, excluding derivatives of naphtospyropyrans, naphtopyrans derivatives and bis-Imidazoles derivatives taken alone or in combination thereof.

7. The dosimeter as defined in claim 2, in which said inhibiting agent is selected from the group consisting of
carbontetrachloride,
bromotrichloromethane,
1,1,2,2 tetrabroethane,
α, α, α-trichlorotoluene,
2,4-dinitrobenzenesulfenylchloride,
ω,ω,ω-tribromoquinaldine,
ω,ω,ω-tribromolepidinebromomethylate,
α,ω,ω-dibromomethyl-4-chloro-pyridine,
2,5-dinitrobromomethyl-3,4-dibromothiophene,
acetophenonederivatives, thioxanthone derivatives taken alone or in combination thereof.

8. The dosimeter as defined in claim 3, in which said absorbing agent is selected from the group consisting of:
2,4-bis(2,4-dimethylphenyl)-6-(2-hydroxy-4-n-octyl-oxyphenyl)-1,3,5-triazine,
2-hydroxy-4-(N-octoxy)benzophenone,
2-(2-hydroxy-5-methyl-phenyl)-2H-benzotriazole,
2-(2H-benzotriazol-2-YL)-4,6-ditertpentylphenol,
2,2′-dihydroxy-4,4′-dimethoxybenzophenone,
2,2′,4,4′-tetrahydroxybenzophenone taken alone or in combination thereof.

9. The dosimeter as defined in claim 4, in which said active chemical compound, said pigment agent and said absorbing agent are homogeneously distributed within the matrix.

10. The dosimeter as defined in claim 1, in which said photochemical reaction may occur by radical dissociation or formation of ions.

11. The dosimeter as defined in claim 1 in which said porous structure is defined by pores size 0.01-0.05 mm, by pores surface density 10-10³ pores/cm² and by pores length 10-100 microns.
